(19) United States
(12) Patent Application Publication
(10) Pub. No.: US 2025/0194633 A1
(43) Pub. Date: Jun. 19, 2025

(54) Extrusion Cooked Legume Protein Composition, Uses and Methods of Manufacture

(71) Applicant: CORN PRODUCTS DEVELOPMENT, INC., Westchester, IL (US)

(72) Inventors: Laura GRAHAM, Bridgewater, NJ (US); Samuel HORMEL, Bridgewater, NJ (US); Ying BIAN, Bridgwater, NJ (US)

(21) Appl. No.: 18/849,582

(22) PCT Filed: Mar. 7, 2023
(86) PCT No.: PCT/US2023/063822

§ 371 Date: Sep. 23, 2024

Related U.S. Application Data
(60) Provisional application No. 63/324,347, filed on Mar. 28, 2022.

(51) Int. Cl. A23J 3/14; A23J 3/26; A23L 11/00; A23L 29/212; A23L 33/125; A23L 33/185; A23P 20/10; A23P 30/20

(52) U.S. Cl. CPC A23J 3/14; A23J 3/26; A23L 11/05; A23L 29/212; A23L 33/125; A23L 33/185; A23P 20/10; A23P 30/20

(57) ABSTRACT

The technology disclosed in this specification pertains to an extrusion cooked vegetable protein composition having protein content greater than about 60% having defined small particle size. In at least some embodiments, the extrusion cooked vegetable proteins are useful as a coatings or fillers in food compositions, for example as a replacement for bread crumbs or wheat flour.

The technology disclosed in this specification pertains to an extrusion cooked vegetable protein composition comprising, as a source material, legume proteins obtained using different treatment processes. The extrusion-cooked vegetable protein compositions are selected for small size and are useful texturizers in various food applications.

Vegetable proteins lack the striation of meat proteins and so, in native form, make textural different compositions than meat. A method commonly used to try to make more meat-like vegetable composition is extrusion cooking. Extrusion cooking means cooking using an extruder, where an extruder is a machine comprising a screw-like shaft within a segmented hollow cylinder. The shaft may itself be segmented and is used to propel a feedstock through the length of the cylinder. The segments of the cylinder and shaft can be configured to supply controllably any of moisture to the feedstock, heat to the feedstock, and shear to the feedstock. The extrusion cooked vegetable proteins described in this specification are further size selected to have small particle size.

In one aspect the technology disclosed in this specification pertains to an extrusion cooked vegetable protein composition made from a mixture of legume proteins. The proteins come from the same type of legume but are processed differently. In another aspect this specification discloses extruder conditions for using a legume protein mixture feedstock to make an extrusion cooked vegetable protein compositions of the type described in this specification. In another aspect, the extrusion cooked vegetable proteins described in this specification are useful as ingredients in food compositions, for example to provide additional protein to a food coating, like a breading, or a batter, or a food filler.

In at least one aspect extrusion cooked vegetable protein compositions described in this specification extrusion cooked vegetable protein composition are selected for small size. In any embodiment described in this specification, an extrusion cooked vegetable protein has a particle size distribution comprising (i) at least about 60% or at least about 65% or at least about 70% up to about 90% of particles or at least about 60% or at least about 65% or at least about 70% up to about 85% of particles that pass through an about 4 mm mesh sieve and (ii) at most about 10% or at most about 5% of particles that pass through an about 0.8 mm mesh sieve wherein, optionally, the extrusion cooked protein composition's particle size distribution further comprises from about 40% to about 60% or to about 50% that rest on sieve having mesh size about 2 mm. The extrusion cooked vegetable proteins described in this specification, have a protein content greater at least about 60%, or in a range from about 60 to about 69%, or about 64% to about 69% by weight of the composition; a carbohydrate in an amount from about 3% to about 9% or from about 3% to about 6% (wt. %).

In any embodiment described in this specification, an extrusion cooked composition is a pea protein or a fava bean protein. In any embodiment described in this specification, an extrusion cooked composition is preferably a pea protein. In any embodiment of an extrusion cooked composition described in this specification the fiber and carbohydrate come from the same legume type as the protein.

During extrusion, moisture is added to the feedstock. This allows the feedstock to undergo a phase transition needed to become the extrusion cooked product. The amount of water, however, is limited and in any embodiment described in this specification, an extrusion cooked composition is the extruded composition has a moisture content (w/w) less than about 10% or from about 5% to about 9% moisture. Following extrusion the extrusion cooked vegetable protein compositions are selected for size. Any method for size selection can be used to obtain an extrusion cooked vegetable protein composition having a particle size distribution comprising (i) at least about 60%, or at least about 65%, or at least about 70%, up to about 90% of particles or about 60% or, at least about 65%, or at least about 70% up to about 85% of particles that pass through an about 4 mm mesh sieve and (ii) at most about 10% or at most about 5% of the particles that pass through an about 0.8 mm mesh sieve wherein, optionally, the extrusion cooked protein composition's particle size distribution further comprises from about 40% to about 60% or to about 50% that rest on sieve having mesh size about 2 mm.

Extrusion cooked vegetable protein compositions having the claimed particles size may be obtained by any suitable method. Illustrative methods include, but are not limited to, cutting or griding the extrusion cooked vegetable protein composition and then sorting the composition for size. In another method, the extruder die is selected to produce an extrusion cooked vegetable protein composition of the desired size. In still another method, extrusion cooked vegetable protein composition may be collections scrap material produced by the extruder having die intended to produce larger size material. In yet another method, extrusion cooked vegetable protein compositions may be collected from breakage of larger extruded material occurring during normal manufacturing processes. All collected materials can be sorted according to size as described elsewhere in this specification.

In any embodiment described in this specification, an extrusion cooked composition has a bulk density of from about 100 to 260 g/L. In any embodiment described in this specification, an extrusion cooked composition has an expansion index of from about 0.79 to about 2.77. In any embodiment described in this specification, an extrusion cooked composition has a molecular weight distribution wherein at least 25% of the proteins in the composition have molecular weight of less than 10 kDa. In any embodiment described in this specification, an extrusion cooked composition has a molecular weight distribution wherein less than 30% of the composition is aggregates having a molecular weight greater than about 250 kDa.

The extrusion cooked vegetable compositions described in this specification are made from a mixture of legume protein compositions. Illustrative, but non-limiting mixtures comprises a first legume protein component in amount of from about 70% to about 90% by weight of the composition, or from about 75% to about 85% or from about 78% to about 82%; and a second legume protein component in an amount of from about 10% to about 30% by weight of the composition, or from about 15% to about 25%, or from about 18% to about 22% wherein the first and second legume protein components are the same legume type. In any embodiment described in this specification, a legume mixture has protein content of from about 60 to about 69%, or about 64% to about 69% by weight of the mixture. In any embodiment described in this specification, a legume mixture further comprises a carbohydrate in an amount from about 3% to about 9% or from about 3% to about 6%. In any embodiment described in this specification, a legume mixture further comprises a fiber in an amount from about 3% to about 9% or from about 5% to about 9%. In any embodiment described in this specification, the protein, carbohydrate, and fiber in a legume protein mixture come from the same legume type.

Generally, the first and second legume protein components are powdered components obtained by milling and optionally further processing legume flour. Methods for milling legumes to make flour are known. In examples, legumes can be dry milled (meaning milling dried legumes) or wet milled (meaning milling rehydrated legumes). Wet milled legumes may further be fermented prior to wet milling. A dry milled composition can be used as is, a wet milled composition can be dried and used as is, or the dry milled or wet milled composition can be further processed.

Protein content of the composition can be increased using any of various useful methods. One illustrative method is air classification, which uses air countercurrents to separate the protein, carbohydrate, and fiber within a flour based on differences in their physical properties. Air classification processes generally do not change structure of proteins or carbohydrate or fibers within the flour. For example protein is generally not denatured in an air classification process, and starch is not gelatinized. Additionally, air classification generally does not separate different types of protein in the composition.

Another method for increasing protein content of a composition is isoelectric point extraction, which relies on solubility differences between protein, fiber and starch to separate them. For example, protein is highly soluble at pH from about 8 to 10 but starch and fiber are not. So in an aqueous dispersion legume flour adjusted to pH of about 9, the substantial amount of protein is dissolved and is be removed as a supernatant or filtrate from the insoluble fiber and starch using filtration or centrifugation. The soluble legume protein is then be recovered by adjusting the pH of the solution to the protein's isoelectric point, generally around pH 4.5, where protein is highly insoluble. A second centrifugation step allows for the protein to be recovered as a precipitate.

Isoelectric point separation and air classification make different legume protein compositions. One difference is that isoelectric point separation is better at isolating the protein from a carbohydrates and starch. Another difference is degree of denaturation of the protein. Another difference is that not all protein will precipitate from solution during isoelectric point separation and some portion of the protein will remain dissolved and be lost. Smaller proteins, by molecular weight, are more likely to remain dissolved and lost. Air classification, which does not dissolve protein, therefore, will have a more complete set of proteins (relative to the natural protein content of the legume, and as measurable by molecular weight distribution) than proteins obtain using an isoelectric point separation.

With reference to a first legume protein component of legume protein mixture, in any embodiment described in this specification, the first legume protein component is an isolated legume protein. In any embodiment described in this specification, a first legume protein component of a legume protein mixture has a protein content in an amount of at least 75% (wt. %), or 75% to about 95% (w/w) of the component. In any embodiment described in this specification, a first legume protein component of a legume protein mixture has denaturation enthalpy of less than about 4 J/g or less than about 1 J/g. In any embodiment described in this specification, a first legume protein component of a legume protein mixture consists essentially of globular or globulin-type proteins. In any embodiment described in this specification, a first legume protein component of a legume protein mixture has a molecular weight distribution which is consistent with being comprised of substantially of globular or globulin type proteins.

With reference to a second legume protein component of legume protein mixture, in any embodiment described in this specification, the second legume protein component of a legume protein mixture comprises a protein in an amount of from about 50% to less than 75% (w/w). In any embodiment the second legume protein component of a legume protein mixture comprises a carbohydrate in an amount from about 3% to about 9% or from about 3% to about 6%. In any embodiment the second legume protein component of a legume protein mixture comprises a fiber in an amount from about 3% to about 9% or from about 5% to about 9%.

In some embodiments a second legume protein component of a legume protein mixture described in tis specification, the protein is legume native protein. In some embodiments a second legume protein component described in this specification, the second component is a legume flour. In other embodiments a second legume protein component is an air classified legume protein. In any embodiment disclosed in this specification, a second legume protein component of a legume protein mixture has a denaturation enthalpy of greater than less than 9 J/g. In any embodiment disclosed in this specification, a second legume protein component of a legume protein mixture comprises essentially all the protein that are in a legume. In any embodiment disclosed in this specification, a second legume protein component of a legume protein mixture comprises essentially has a molecular weight distribution of legume protein essentially the same as the molecular weight distribution of the protein in a legume. In any embodiment disclosed in this specification, a second legume protein component of a legume protein mixture comprises starch that is not gelatinized.

In any embodiment a legume protein mixture has a molecular weight distribution being the combined molecular weight distribution of the first and second legume protein components. In any embodiment a legume protein mixture has a denaturation enthalpy being the combined denaturation enthalpy of the first and second legume protein component.

The thermodynamic properties of the legume protein mixture can also be assessed with reference to onset, endpoint, and mean phase transition temperatures (Tₛ) and flow temperature (T_{f}) of the material. In any embodiment a legume protein mixture has a flow temperature (T_{f}) of from about 42° C. to about 187° C. In any embodiment a legume protein mixture has an onset temperature phase transition temperature (Tₛ) of about 15° C. to about 44° C. In any embodiment a legume protein mixture has an endpoint phase transition temperature (Tₛ) of 42° C. to 110° C. In any embodiment a legume protein mixture has a mean phase transition temperature (Tₛ) of about 31° C. to about 77° C.

In any embodiment a legume protein mixture has a compressibility of from about 30% to about 60%, measured as described in this specification. In any embodiment a legume protein mixture has a flowability index of from about 30 to about 60, measured as described in this specification.

In yet another aspect, this specification discloses a method for making an extrusion cooked vegetable protein composition. The method can be applied to any feedstock described in this specification. The method can be used to make any feedstock described in this specification. In any embodiment, this specification discloses, A method of making an extrusion cooked vegetable protein composition comprising obtaining a mixture of: (i) a first legume protein component in amount of from about 70% to about 90% by weight of the composition, or from about 75% to about 85% or from about 78% to about 82%; and (ii) a second legume protein component in an amount of from about 10% to about 30% by weight of the composition, or from about 15% to about 25%, or from about 18% to about 22%; feeding the mixture into an extruder; and extruding the mixture using the extruder wherein the first and second legume protein components are the same legume type.

In any embodiment a method for making an extrusion cooked vegetable protein composition wherein the extruding step comprises extruding the mixture using a specific mechanical energy of from about 250 to about 270 W*hr/kg. In any embodiment a method for making an extrusion cooked vegetable protein composition wherein an extruding step comprises applying to the mixture during extruding a pressure from about 40 to about 50 bar or from about 40 to about 45 bar. In any embodiment a method for making an extrusion cooked vegetable protein composition wherein an extruding step comprises operating a screw-like shaft within a segmented hollow cylinder of the extruder at a rate of from about 390 to about 410 revolutions per minute.

In another aspect, this specification discloses use of an extrusion cooked vegetable protein in a food composition. In any embodiment described in this specification a food composition comprise an extrusion cooked vegetable protein composition made according to a process as described in any foregoing claim and a second edible ingredient. Food compositions described in this specification use an extrusion cooked vegetable protein in any amount (1% to 99%). More commonly food compositions described in this specification comprise an extrusion cooked vegetable composition in an amount from 1% to 1 bout 30% or from about 10% to 30% or from about 15% to about 25% (wt. %). In various embodiments an extrusion cooked vegetable protein composition is used in an amount greater than about 35% (wt. %) by weight of from about 40%, or from about 50% or from about 60% or from about 80% or from about 90% to from about 100% or from about 40% to about 100% or to about 90% or to about 70% or to about 60% or to about 50%, or in an amount from about 40% to about 60% or about 40% to about 50%. Food compositions may be prepared or stored in any common manner including by freezing, baking, frying and mixtures thereof.

The extrusion cooked vegetable protein compositions described in this specification are useful as ingredients in food compositions. In some uses as a food ingredient, the extrusion cooked vegetable protein compositions are be rehydrated before use. Advantageously, the extrusion cooked vegetable protein compositions described in this specification rehydrate quickly at ambient temperature while retaining good firmness. In any embodiment described in this specification an extrusion cooked vegetable protein composition can be hydrated by soaking in water (without mixing or agitation) for 10 minutes 5 minutes to hold from 300% to 450% of its weight in water (a water holding capacity of from about 3.0 to about 4.5 g/g) and have a firmness of from about 3200 g and 5400 g, or from about 3500 g to about 4500. An extrusion cooked vegetable protein composition, as described in this specification, obtains the described hydration after soaking at ambient conditions using untreated tap water or deionized water or other aqueous solution. In a useful test for measuring hydration capacity, an extrusion cooked vegetable composition is hydrated in water in a ratio of about 1-part composition to 5 parts water under ambient conditions. Here, ambient temperature is meant to cover a range of conditions that would normally be experienced at cite where an extrusion cooked vegetable composition will be used to make a food product, for example, air pressures of about 1 atmosphere and temperatures from about 10° C. to about 30° C.

In other embodiments of food compositions described in this specification, an extrusion cooked vegetable protein composition is used without rehydration. In at least some embodiments an extrusion cooked vegetable protein composition is used to coat an edible substrate. The coating may be in the form of a batter-like coating where the extrusion cooked vegetable protein composition is mixed with water and other ingredients to form a batter that is used to coat an edible substrate. Alternately, the coating may form a breading-like coating where the extrusion cooked vegetable protein composition is mixed with other ingredients to form a dry coating of a substrate. In the form of a dry coating or breading-like coating, the coating may adhere to the substrate because of moisture in the substrate or application of some adhesion syrup, or batter, or other adhesion material that adherers to both the substrate and dry coating. In still other embodiments described in this specification an extrusion cooked vegetable protein is used as a filler, such as a gluten free replacement for breadcrumbs.

In any embodiment described in this specification a coating for an edible substrate comprises an extrusion cooked vegetable protein composition and a second edible ingredient. The second edible ingredient may be any useful second edible ingredient including but not limited flavorings, seasonings, preservatives, sweeteners, hydrocolloids (including gums, modified starches, and modified cellulosic fibers) other protein powders, fibers (cellulosic or otherwise) starches, flours, and any mixtures of any of the foregoing.

Useful starches and flours include but are not limited to wheat flour, rice flour, waxy rice flour, tapioca flour, waxy tapioca flour, tapioca starch, waxy tapioca starch, waxy rice starch, rice starch, corn starch, waxy corn starch, pea starch, potato starch, waxy potato starch, high amylose corn starch and mixtures thereof. Starches and flours may be unmodified, including native starches and gelatinized starches that are not otherwise modified. Starches and flours may also be modified for example by oxidation, stabilization (for example acetylation or hydroxypropylation), etherification reactions, esterification reactions, acid hydrolysis, enzymatic modification (including enzymatic hydrolysis), thermal inhibition, heat-moisture treatment, and chemical inhibition (for example using phosphate, adipate) and mixtures thereof.

When used as a coating for a food composition, an extrusion cooked vegetable protein may be used in any useful amount relative to other ingredients. In various embodiments an extrusion cooked vegetable protein composition is used in an amount greater than about 35% (wt. %) by weight of from about 40%, or from about 50% or from about 60% or from about 80% or from about 90% to from about 100% or from about 40% to about 100% or to about 90% or to about 70% or to about 60% or to about 50%, or in an amount from about 40% to about 60% or about 40% to about 50%.

Edible substrates to be coated can be selected from the group consisting of vegetables, potatoes, squash, carrots, broccoli, mushrooms, peppers, nuts, legumes, meats, fish, poultry, chicken, beef, pork, veal, meat analogs and mixtures thereof.

In other embodiments the extrusion cooked vegetable protein can be used as a filler, particular to replace a breadcrumb filler. In such embodiments the extrusion cooked vegetable protein is in an amount from about 0.1% to about 10%, or from about 1% to about 10%, or to about 9%, or to about 8%, or to about 7%, or two about 6%, or in an amount from about 1% or about 2%, or about 3%, or about 4%, to about 6%. In at least some embodiments food composition are analog meat compositions comprised of larger form extrusion cooked vegetable protein. In at least one embodiment the food composition comprises as a second ingredient an extrusion cooked vegetable protein having a particle size distribution wherein about 75% or particles having a sieved particle size greater than about 6 mm.

The following definitions and comments are useful for interpreting this specification and understanding the technology disclosed within.

Within this specification the term “carbohydrate” when used with reference to the legume protein mixtures and extrusion cooked vegetable protein compositions described in this specification, is limited to starch or from sugars and polysaccharides derived from starch.

Within this specification, “isolated legume protein” refers to a composition of substantially pure legume protein. The composition is powdered (not extruded) and has at least 75% protein by weight of the composition. Various methods for isolating legume protein are known in the art and within this specification isolated legume protein is not limited to the method of its isolation. In at least some embodiments an isolated legume protein is isolated in a process that uses different pH at different steps of the process to isolate the protein. Processes using sequential pH adjustments tend to have three results. First, the isolated legume protein is a protein type that is not very soluble in water, like globulin protein or globular-type proteins. Second, water soluble protein tends to be lost when the insoluble protein is recovered, which can be seen using SDS-PAGE comparing isolated protein and with native legume protein. Third, the pH adjustments may denature the recovered protein as determinable by differential scanning calorimetry.

Within this specification “native legume protein” refers to legume protein in a milled composition that is not further modified, for example it is substantially not denatured, as determinable, for example, using differential scanning calorimetry. Native legume protein may exist in whole legume flour or it may exist in a protein rich legume flour if the process used to increase relative protein content does not substantially denature the legume protein. Various methods are known in the art for obtaining native legume protein, and within this specification native legume protein can be obtained by any method. In at least some embodiments a native legume protein is obtained using air classification to obtain a protein rich legume flour (protein content between about 50% and about less than 75%). In addition to being substantially not denatured, native legume proteins comprise essentially all the protein in a legume meaning it comprises, for example, globular-type (generally water insoluble) proteins and albumin-like (generally water soluble) proteins, which can be seen using SDS-PAGE.

Within this specification particle size distribution is measured by particles that pass through or rest on a sieve of defined mesh size.

Within this specification the term “the same legume type” refers to legumes that, within the ordinary understanding within the art, would be understood to be the same. As use dictates this may mean within the same species or subspecies. Also, a legume may be of the same type although known by different common names. As non-limiting examples, in some embodiments the first and second legume protein components are from pea (Pisum sativum). In another non-limiting example, in other embodiments the first and second legume protein components are from fava bean (Vicia faba). Within this specification the first and second legume protein components are intended to come from the same type of legume but are obtained by methods causing the first and second legume protein components to have different physical and functional properties from each other.

Within this specification, the term “thermal inhibition” refers to a method for modifying starch by heating an essentially anhydrous starch (moisture content less than about 2% wt. %). The starch is heat at temperatures generally above 100° C. The result of the process is to make a starch that performs like chemically crosslinked starch without use of a chemical crosslinker. Thermal inhibition methods for starches and flours are described in more detail in World Intellectual Property Pub. No. WO 2020-139997, which is incorporated into this specification in its entirety.

Within this specification “unhydrated” with respect to an extrusion cooked vegetable protein composition refers to the composition in low moisture form. In at least some embodiments, following extrusion an extrusion cooked vegetable protein composition has water content less that about 10% (wt. %).

Reference in this specification to “partially denatured legume protein” refers to legume proteins that have lower denaturation enthalpy (as measurable using differential scanning calorimetry) than native proteins but that still have substantial denaturation enthalpy, meaning they can be denatured further. Partially denatured legume protein is obtained by applying a denaturation process to a native legume protein source whether for example a whole legume flour or a protein rich legume flour. Although not limited by process, in at least some embodiments, a partially denatured legume protein is obtained by applying a heating an air classified protein rich legume flour in limited water so that the water used is absorbed by the protein rich flour and a slurry or dispersion of the flour is not formed. Obtained in this manner, the partially denatured legume protein still comprises essentially all the proteins within a legume.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology described in this specification can be further understood with reference to the following non-limiting aspects, which are provided for illustrative purposes and are not intended to limit the full scope of the invention.

1. An extrusion cooked vegetable protein composition wherein the extrusion cooked vegetable protein composition has a particle size distribution comprising (i) at least about 60% or at least about 65% or at least about 70% up to about 90% of particles or at least about 60% or at least about 65% or at least about 70% up to about 85% of particles that pass through an about 4 mm mesh sieve and (ii) at most about 10% or at most about 5% of the particles that pass through an about 0.8 mm mesh sieve wherein, optionally, the extrusion cooked protein composition's particle size distribution further comprises from about 40% to about 60% or to about 50% of particles that rest on sieve having mesh size between about 2 mm wherein optionally, the legume protein is either a pea protein or a fava bean protein.

2. An extrusion cooked vegetable protein composition comprising: a legume protein from a single legume type in an amount of from an amount from about 60 to about 69%, or about 64% to about 69% by weight of the composition; and a carbohydrate in an amount from about 3% to about 9% or from about 3% to about 6%; wherein the extrusion cooked vegetable protein composition has a particle size distribution comprising (i) at least about 60% or at least about 65% or at least about 70% up to about 90% of particles or at least about 60% or at least about 65% or at least about 70% up to about 85% of particles that pass through an about 4 mm mesh sieve and (ii) at most about 10% or at most about 5% of the particles that pass through an about 0.8 mm mesh sieve wherein, optionally, the extrusion cooked protein composition's particle size distribution further comprises from about 40% to about 60% or to about 50% of particles that rest on sieve having mesh size between about 2 mm wherein optionally, the legume protein is either a pea protein or a fava bean protein.

3. The extrusion cooked vegetable protein composition of claim 1 or 2 wherein when soaked in ambient temperature deionized water for 10 minutes, or 5 minutes the extrusion cooked vegetable protein has: a water holding capacity of from about 3.0 to about 4.5 g/g; and a firmness or from about 3200 g and 5400 g, or from about 3500 g to about 4500 g.

4. The extrusion cooked vegetable protein composition of claim 1 or 3 further comprising a fiber in an amount from about 3% to about 9% or from about 5% to about 9%.

5. The composition of any one of claims 1 to 4 further having a bulk density of from about 100 to 260 g/L.

6. The composition of any one of claims 1 to 5 being having unhydrated moisture content of less than about 10% w/w, or from about 5% to about 9%.

7. The composition of any one of claims 1 to 6 having a molecular weight distribution wherein at least 25% of the proteins in the composition have molecular weight of less than 10 kDa.

8. The composition of any one of claims 1 to 7 having a molecular weight distribution wherein less than 30% of the composition is aggregates having a molecular weight greater than about 250 kDa.

9. The composition of any one of claims 1 to 8 having an expansion index of from about 0.79 to about 2.77.

10. The composition of any one of claims 1 to 9 wherein the protein, carbohydrate and, optionally, fiber are from pea.

11 A food composition comprising the extrusion cooked vegetable protein composition of any one of claims 1 to 10 and a second edible ingredient.

12 The food composition of claim 11 wherein the second ingredient is an edible substrate, and wherein the extrusion cooked vegetable protein composition coats the edible substrate.

13 The food composition of claim 11 or 12 wherein the extrusion cooked vegetable protein composition coats an edible substrate and wherein the coating further comprises a starch or flour.

14 The food composition of any one of claim 11 or 13 wherein the extrusion cooked vegetable protein composition coats an edible substrate and wherein the coating further comprises a starch or flour selected from the group consisting of wheat flour, rice flour, waxy rice four, tapioca flour, waxy tapioca flour, tapioca starch, waxy tapioca starch, waxy rice starch, rice starch, corn starch, waxy corn starch, pea starch, potato starch, waxy potato starch, high amylose corn starch and mixtures thereof.

15 The food composition of any one of claim 11 or 14 wherein the extrusion cooked vegetable protein composition coats an edible substrate and wherein the coating further comprises a starch or flour wherein the second starch or flour is unmodified.

16 The food composition of any one of claim 11 or 15 wherein the extrusion cooked vegetable protein composition coats an edible substrate and wherein the coating further comprises a modified starch, and wherein the modification comprises one or more of thermal inhibition, heat-moisture treatment, and chemical inhibition.

17 The food composition of any one of claims 11 to 16 wherein the extrusion cooked vegetable protein composition coats an edible substrate, and the coating comprises extrusion cooked vegetable protein composition in an amount greater than about 35% (wt. %) by weight of from about 40%, or from about 50% or from about 60% or from about 80% or from about 90% to from about 100% or from about 40% to about 100% or to about 90% or to about 70% or to about 60% or to about 50%, or in an amount from about 40% to about 60% or about 40% to about 50%.

18 The food composition of any one of claims 11 to 17 wherein the food composition is frozen.

19 The food composition of any one of claims 11 to 18 wherein the food composition is fried.

20 The food composition of any one of claims 11 to 19 where the second ingredient is an edible substrate that is coated by the extrusion cooked vegetable protein composition, and wherein the edible substrate is selected from the group consisting of vegetables, potatoes, squash, carrots, broccoli, mushrooms, peppers, nuts, legumes, meats, fish, poultry, chicken, beef, pork, veal, meat analogs and mixtures thereof.

21 The food composition of claim 11 wherein the extrusion cooked vegetable protein composition in an amount greater than about 35% (wt. % of the food composition) by weight of from about 40%, or from about 50% or from about 60% or from about 80% or from about 90% to from about 100% or from about 40% to about 100% or to about 90% or to about 70% or to about 60% or to about 50%, or in an amount from about 40% to about 60% or about 40% to about 50%.

22 The food composition of claim 21 wherein the second ingredient is a starch or flour selected from the group consisting of wheat flour, rice flour, waxy rice four, tapioca flour, waxy tapioca flour, tapioca starch, waxy tapioca starch, waxy rice starch, rice starch, corn starch, waxy corn starch, pea starch, potato starch, waxy potato starch, high amylose corn starch and mixtures thereof.

23 The food composition of claim 21 or 22 wherein the starch or flour wherein the second starch or flour is unmodified.

24 The food composition of any one of claims 21 to 23 wherein the extrusion cooked vegetable protein composition coats an edible substrate and wherein the coating further comprises a modified starch, and wherein the modification comprises one or more of thermal inhibition, heat-moisture treatment, and chemical inhibition.

25. The food composition of claim 11 wherein the extrusion cooked vegetable protein is a filler within the food composition.

26. The food composition of claim 11 or 25 wherein the extrusion cooked vegetable protein is in an amount from about 0.1% to about 10%, or from about 1% to about 10%, or to about 9%, or to about 8%, or to about 7%, or two about 6%, or in an amount from about 1% or about 2%, or about 3%, or about 4%, to about 6% (wt % of the food composition).

27. The food composition of claim 11, 25 or 26 herein the second edible ingredient is an extrusion cooked vegetable protein having a particle size distribution wherein about 75% or particles having a sieved particle size greater than about 6 mm.

28 Use of the extrusion cooked vegetable protein composition of any one of claims 1 to 10 to coat an edible substrate.

29 A method comprising: applying an extrusion cooked vegetable protein composition as described in any one of claims 2 to 10 or the food composition of any one of claims 21 to 24 to an edible substrate to form a coated food composition wherein, optionally, the food composition is frozen; wherein, optionally, the food composition is fried; wherein optionally, the edible substrate is selected from the group consisting of vegetables, potatoes, squash, carrots, broccoli, mushrooms, peppers, nuts, legumes, meats, fish, poultry, chicken, beef, pork, veal, meat analogs and mixtures thereof.

30 A method of making an extrusion cooked vegetable protein composition comprising (a) obtaining a mixture of: (i) a first legume protein component in amount of from about 70% to about 90% by weight of the composition, or from about 75% to about 85% or from about 78% to about 82%; and (ii) a second legume protein component in an amount of from about 10% to about 30% by weight of the composition, or from about 15% to about 25%, or from about 18% to about 22%; (b) feeding the mixture into an extruder; (c) extruding the mixture using the extruder to obtain an extrusion cooked vegetable protein composition; and (d) selecting a particle size distribution such that the extrusion cooked vegetable protein composition so that the extrusion cooked vegetable protein composition has a particle size distribution comprising (i) at least about 60% or at least about 65% or at least about 70% up to about 90% of particles or at least about 60% or at least about 65% or at least about 70% up to about 85% of particles that pass through an about 4 mm mesh sieve and (ii) at most about 10% or at most about 5% of the particles that pass through an about 0.8 mm mesh sieve wherein, optionally, the extrusion cooked protein composition's particle size distribution further comprises from about 40% to about 60% or to about 50% of particles that rest on sieve having mesh size between about 2 mm; wherein optionally, the legume protein is a pea protein or a fava bean protein; and wherein the first and second legume protein components are the same legume type; wherein optionally, the legume protein is a pea protein or a fava bean protein.

31 The method of claim 30 wherein the second legume protein component is a native legume protein component, wherein, optionally, the native legume protein has a denaturation enthalpy greater than 9 J/g.

32 The method of claim 31 or 32 wherein the first legume protein component has a denaturation enthalpy of less than about 4 J/g or less than about 1 J/g.

33 The method of any one of claims 31 to 33 wherein the extruding step comprises extruding the mixture using a specific mechanical energy of from about 250 to about 270 W*hr/kg.

The technology described in this specification can be further understood with reference to the following non-limiting examples that are provided for illustrative purposes and are not intended to limit the full scope of the invention.

### EXAMPLE 1—EXTRUSION COOKED PEA PROTEIN COMPOSITION

Extrusion cooked vegetable proteins were made from a mixture of isolated pea protein (about 75% to 80% protein content wt. %) with a native pea protein (about 50% to about 55%) to obtain a target protein content of the blend of from 55% to 85%. The obtained extrusion cooked vegetable protein compositions were from a pea protein mixture having the measured properties reported in Table 1.

TABLE 1
Feedstock for Extrusion Cooked
Vegetable Protein Composition

| Property | Blend |
|---|---|
| Protein content , % | 55-84 |
| Moisture content, % | 5-9 |
| Compressibility, % | 35-60 |
| Flowability index | 46-50 |
| Flow temp, T_{f} (° C.) | 42 |
| Onset temp, Tₛ (° C.) | about 20 |
| Endpoint temp, Tₛ (° C.) | about 50 |
| Mean Tₛ (° C.) | about 36 |
| Particle size (dia), μm | less than 150 |

The feedstock was extruded to obtain extrusion cooked vegetable proteins using the following generalized process. Dry powder was blended and transferred to a feeder, which meters the dry protein powder blend into the extruder or preconditioner at a set rate. Water was added to the extruder and the water and protein powder blend were mixed and pushed through the extruder and extruded. The composition exiting the extruder was cut to the desired size and dried to specified moisture content of less than about 10% (wt. %). All extruded samples were made using the following parameters. Specific mechanical energy applied is 260 W*hr/kg. The internal pressure was 43 bar, and the internal shaft was rotated at 400 revolutions per minute.

Properties of the extrusion cooked vegetable protein compositions made using the feedstock described in Table 1 are reported in Table 2.

TABLE 2
Physical Properties of Extrusion Cooked

| Property | Blend 2 |
|---|---|
| Protein content, % | 67-69 |
| Moisture content, % | 5-9 |
| Hydrated hardness, g @5 m | 2699-5093 |
| Hydrated hardness, g @10 m | 2222-4656 |
| Bulk density, g/L | 116-374 |
| WHC, g/g | 2.8-4.2 |
| WHC, % | 227-414 |
| Expansion index | 0.79-2.77 |
| Molecular weight, <10 kDa, % | >25 |
| Molecular weight, | <30 |
| aggregates >250 kDa, % | |

### EXAMPLE 2—METHODS

Measurements taken and reported in this specification were measured as follows.

Determination of compressibility and flowability of granulated plant protein (AL-HPT-001): Compressibility and flowability were obtained using the Hosokawa micron powder system. The compressibility measurement is defined by R L Carr and is determined by the relative measurement of loose and packed bulk density. Any material having a value of more than 20% may need some external measures to prevent bridge formation whether in a hopper or a storage bin.

Determination of thermal properties of granulated plant protein: A Phase Transition Analyzer (PTA; Wenger Manufacturing, Sabetha, KS) was used to measure the phase transition temperature (Ts) and flow temperature (Tf) with modification from method used by Oterhals and Samuelsen (2015). The principle is based on the measurement of change in height (sample volume) with respect to temperature increase (8° C./min) at constant pressure (100 bars). After Ts measurement, the blank insert (no capillary opening) is replaced with a 1.75 mm capillary opening. The temperature is further increased at the same rate and a Tf defined as the temperature level initiating start of flow through the capillary die. The onset, endpoint and mean Ts were recorded at four (4) different moisture contents (10-20%).

Determination of molecular weight distribution of granulated plant protein and textured plant protein: Plant proteins are analyzed using Laemni conditions using a stain free Imaging technology approach with Mini-PROTEAN Tetra Cell and EZ ImageLab scanner.

Determination of hydrated hardness of textured plant protein (ISP Method): Extruded proteins were sieved using a size #8 US mesh. Samples that remained on top of sieve were retained for hardness testing. About 5 g of extruded proteins were weighed into a 150 ml plastic beaker. About 15 g of DI water was added to this beaker for a textured protein: water ratio of 1:3. The mixture was stirred for the first 1-2 minutes and left to hydrate for 5 min and 10 min. After hydration at specified times, the samples were transferred into a weighing boat and mixed by hand for about 1 min. Sample was then transferred to a 4 oz round aluminum container as show in the image and then evaluated on a texture analyzer. Hardness of the hydrated samples were measured using a compressive force using TA-11 probe, 5 kg load cell and 50% strain on a TA.XTPlus texture analyzer.

Determination of bulk density of textured plant protein (ISP Method): The textured proteins were sieved using a size #8 US mesh. Samples that remained on top of sieve was retained for bulk density measurements. Textured proteins that were not approximately 1 mm in size were broken up with hand to 1 mm size before weighing. A seedburo filling hopper and stand (SKU: V041.151) was used for bulk density measurements. The empty pint cup was placed on balance and then tared. The pint cup was then removed from balance and placed in hopper on stand. The pint cup was filled by pouring sample from top of the hopper. Once the cup was filled, the ruler was used to level the top. The cup was placed on the balance and then weighed. Samples were tested in duplicate. The weight of the textured proteins was calculated using the conversion:

$$textured protein density ( g / L ) = textured protein weight ( g ) / jar volume ( L ) and 1 pint [ US , dry ] = about 0.551 liter .$$

Determination of water holding capacity (WHC) of textured plant protein (ISP Method): The textured proteins were sieved using a size #8 US mesh. All textured proteins that remained on top of sieve were retained for water holding capacity (WHC) measurements. Textured proteins were weighed into a weighting boat and the weight was recorded. The samples were poured into an 8 oz jar. DI water was weighed and added to the 8 oz jar containing the textured protein sample at room temperature for a textured protein: water ratio of 1:5. The weight of the water was recorded. The jar was tapped tightly, and textured protein hydrated for either 5 minutes or 10 minutes. The jar was flipped over after 5 minutes to ensure all textured protein pieces were soaked. After the set time (5 minutes or 10 minutes) a kitchen strainer was used to filter the soaked textured protein sample until no more water passed through the strainer. The wet textured proteins were weighed and recorded. A spoon was used to transfer the sample from the strainer to a weighting boat. The WHC was calculated using the equation:

$$\% WHC = ( \frac{weight of wet sample - weight of dry sample}{weight of dry sample} ) * 100$$

Determination of sectional expansion index (SEI) of textured plant protein: The sectional expansion index (SEI) was determined as suggested by Alvarez-Martinez et al. (1988) and utilized by Beck et al. (2017). The SEI is the ratio between the cross-sectional area of the textured plant protein (Sₜₚₚ) and the cross-sectional area of the die (S_{d}). The diameter of the textured plant protein (Dₜₚₚ) was measured three times on ten samples, resulting in 30 measurements of the diameter, which is within the suggested size of 30 samples for a representative determination of the degree of expansion (Patil et al., 2007). The EI was calculated using the equation:

$$SEI = \frac{{S}_{t p p}}{{S}_{d}} = \frac{( π {D}_{tpp}^{2} ⋆ 0.25 )}{( π {D}_{d}^{2} ⋆ 0.25 )} = {( \frac{{D}_{tpp}}{{D}_{d}} )}^{2} = {( EI )}^{2}$$

### EXAMPLE 3—USE OF AN EXTRUSION COOKED VEGETABLE PROTEIN AS A WHEAT FLOUR REPLACEMENT IN BREADING

Extrusion cooked vegetable protein was used as substitute for at least of part of the wheat flour in a batter-and-breading coating of an edible substrate. The coated substrate was then fried. In this example the coated food substrate was whole meat, white meat chicken cut into nugget size pieces.

Extrusion cooked vegetable protein was made as described in Example 1. Material was classified using sieves to obtain a standardized particle size of less than #16 mesh (1.19 mm). Extruded material was placed on stacked #8 mesh (2.38 mm) and #16 mesh sieves, which were shaken (roto-tap sieve shaker). Material through the #16 mesh sieve was collected and used to make batters.

Various breading mixes were made using extrusion cooked vegetable protein. Mixes Were either 100% extrusion cooked vegetable protein or a two-component mix of extrusion cooked vegetable protein and wheat flour. Two component mixes were made in a range from 10:90 (wt. %) extrusion cooked vegetable protein to wheat flour through 90:10 extrusion cooked vegetable protein to wheat flour through, increasing the amount of extrusion cooked vegetable protein in 10 increments. Chicken was battered using a pre-dusting blend, then coated with a batter, and then breaded with extrusion cooked vegetable protein. Coatings were evaluated for sensory impressions.

Table 3 describes the formula for the pre-dusting breading.

TABLE 3
Pre-dusting Breading Formula

| Ingredient | Wt. % |
|---|---|
| Modified corn starch | 30.00 |
| All Purpose Wheat Flour | 70.00 |
| Total | 100.00 |

Prior to coating food substrate, pre-dust is prepared by mixing starch flour together to homogenized.

Table 4 reports the batter formula, dry ingredient only.

TABLE 4
Batter Formula (Dry Ingredients)

| Batter | (wt.%) |
|---|---|
| All Purpose Wheat Flour | 93.00 |
| Salt | 6.00 |
| Sodium Bicarbonate | 0.50 |
| SAPP #28 (Sodium Acid | 0.50 |
| Pyrophosphate) | |
| Total | 100.00 |

Batter was made by mixing dry ingredient of Table 4 to homogenize. Water was added to pre-blended dry batter and hydrated to 35% solids and mixed to homogenize. Batter viscosity was measured using Zahn cup #4 to have a viscosity 12.36 seconds to break. (Zhan viscosity is a standardized method for measuring viscosity of certain viscous liquids. To determine the viscosity, the cup was submerged in the batter to fill the cup completely. The cup is removed from the batter and observes the flow of material through a hole in cup's bottom. Timing begins when the cup first breaks the surface of the batter and stops when the continuous flow of batter through the hole first breaks and begins dripping).

Table 5 reports breading samples made with extrusion cooked vegetable protein and optionally all-purpose wheat flour.

TABLE 5
Breading Ratios (Extrusion Cooked Vegetable
Protein to All-purpose Wheat Flour)

| | Ratio (extrusion cooked vegetable |
|---|---|
| Sample | protein: All-purpose wheat flour |
| 1 | 10:90 |
| 2 | 20:80 |
| 3 | 30:70 |
| 4 | 40:60 |
| 5 | 50:50 |
| 6 | 60:40 |
| 7 | 70:30 |
| 8 | 80:20 |
| 9 | 90:10 |
| 10 | 100:0 |

Prior to coating, extrusion cooked vegetable protein and all-purpose wheat flour (when used) were mixed to homogenize.

Chicken was prepared with batters as follows. Chicken was cut into 11 to 13-gram pieces, which were then coated with pre-dust and excess was shaken off. Dusted chicken was fully submerged into batter until evenly coated. Excess batter was allowed to drip off. Battered chicken was tossed in breading mix until the chicken was evenly coated and not longer sticky on the surface. To finish chicken preparation, the pre-dusted, battered, and breaded chicken was par-fried at 380° F. (about 193° C.) for 50-60 seconds and then frozen about −20° to −30° C. using forced air blast freezer for at least one hour and transferred to standard freezer for storage at about −18° C. Chicken was fried while frozen, oil temperature of 375° F. (about 190° C.) for a time of 4.5 minutes. Samples were then divided into three groups. One was held under heat lamp for 5-minutes. Another was held under heat lamp for 10-minutes. The third was held for 15-minutes without use of heat lamp. Samples were evaluated informally by laboratory staff for color, general appearance, crispiness, and toughness. Comments were recorded and are reported in Table 6.

TABLE 6
Sensory Evaluation of Fried Chicken Nuggets

| | Ratio | |
|---|---|---|
| | (extrusion cooked | |
| | vegetable protein: | |
| | All-purpose | |
| Sample | wheat flour | Sensory Notes |
| 1 | 10:90 | Acceptable-Light and crispy |
| 2 | 20:80 | Acceptable-Light and crispy |
| | | with slight hardness detected |
| 3 | 30:70 | Acceptable-Slightly |
| | | crunchier than 20:80 |
| | | ratio. Some flavor detected |
| 4 | 40:60 | Acceptable-Some flavor detected, |
| | | but texture is still crispy/crunchy |
| 5 | 50:50 | Acceptable-Still crunchy, |
| | | but becoming dry, |
| | | tough and providing a |
| | | shorter texture |
| 6 | 60:40 | Acceptable-Adheres to substrate, |
| | | but coating has become |
| | | dry and tough |
| 7 | 70:30 | Acceptable-Similar to 60:40 ratio |
| 8 | 80:20 | Acceptable-Similar to 60:40 ratio |
| 9 | 90:10 | Acceptable-Similar to 60:40 ratio |
| 10 | 100:0 | Acceptable-Similar to 60:40 ratio |

Observations are summarized as follows. Nuggets developed color (had more browning) at higher protein usage levels. Breading and batter provided no noticeable color to Sample 1, (10:90), which had color like the cooked chicken. Browning increased with increased protein usage and was deemed in a commercially desirable range at and above a 40:60 use ratio (Samples 4 to 10). Increased protein levels also increased toughness of bite and nuggets were drier. Samples 4 and 5 produced optimal ratio in terms of texture and appearance.

### EXAMPLE 4—USE OF AN EXTRUSION COOKED VEGETABLE PROTEIN AS A BREAD CRUMB REPLACEMENT

Extrusion cooked vegetable protein was used as substitute for breadcrumbs. Chicken nugget samples were prepared through application of batter was described in Example 3. Chicken nuggets were pre-dusted using blends like those described in Table 3 and then coated with a batter as described in Table 4. Three samples were made one used panko breadcrumbs (100% or breading), one used extrusion cooked vegetable protein having sieved particle size distribution as described for Example 3 (100% or breading), one used extrusion cooked vegetable protein having particle size distribution wherein at least about 75% of particles had a sieved particle size of at than about 6 mm (100% of breading). Pre-dusted, battered, and breaded chicken nuggets were fried as described in Example 3. Cooked chicken nuggets were visually inspected, and comments are recorded in Table 7

TABLE 7
Visual Evaluation of Breaded Chicken Nuggets

| Texture and Appearance | Appearance | Texture |
|---|---|---|
| Panko breadcrumbs | Smooth | Hard crisp |
| Extrusion Cooked Vegetable Protein | Smooth | Light crisp |
| (distribution as described in Example 3) | | |
| Extrusion Cooked Vegetable Protein | Rough | Slightly harder |
| (75% or particles have a sieved | | crisp |
| particle size greater than about 6 mm) | | |

Chicken nuggets breaded with extrusion cooked vegetable protein (less than about 2 mm) had smooth appearance like chicken nuggets breaded with panko breadcrumbs but were rated as light crisp compared to hard crisp for panko breadcrumbs. Chicken nuggets breaded with extrusion cooked vegetable protein (particle size distribution of about 75% or particles having a sieved particle size greater than about 6 mm) had rough appearance and slightly harder texture than chicken nuggets breaded with extrusion cooked vegetable protein (particle size distribution as described in Example 3). This show that with extrusion cooked vegetable protein (with particle size distribution as described in Example 3) are a useful replacement for breadcrumbs, like panko breadcrumbs.

### EXAMPLE 5—USE OF AN EXTRUSION COOKED VEGETABLE PROTEIN AS A BREAD CRUMB FILLER REPLACEMENT

This examples illustrates use of an extrusion cooked vegetable protein having a particle size distribution as described in Example 3 as a replacement for a bread crumb in a food composition. The model formulation is a vegan meatball alternative is reported in Table 8.

TABLE 8
Vegan Meatball-Alternative Formulation

| | Formula A | Formula B |
|---|---|---|
| Ingredients | (wt.%) | (wt.%) |
| Extrusion cooked | 19.00 | 19.00 |
| vegetable protein (75% or | | |
| particles having a sieved | | |
| particle size greater than | | |
| about 6 mm) | | |
| Water 1 | 52.25 | 50.25 |
| Gum Blend | 3.00 | 0.00 |
| Gum and Starch Blend | 0.00 | 5.00 |
| Pea protein isolate | 2.50 | 2.50 |
| (about 85% protein wt. %) | | |
| Extrusion cooked | 5.00 | 5.00 |
| vegetable protein | | |
| (particle size distribution | | |
| as described in Example 3) | | |
| Seasoning Blend | 1.80 | 1.80 |
| Flavors | 1.50 | 1.50 |
| Colors | 0.95 | 0.95 |
| Salt | 1.00 | 1.00 |
| Coconut Oil | 13.00 | 13.00 |
| Total | 100.00 | 100.00 |

Vegan meatball alternative was made as follow. Extruded vegetable protein (75% or particles having a sieved particle size greater than about 6 mm) was mixed with water to hydrate and color was added. Remaining ingredients were mixed to form a binder/filler mixture. Balls were formed, frozen overnight and then bake at 375° F. (about 190° C.) for 10 minutes.

1. An extrusion cooked vegetable protein composition having protein content greater than about 60%
wherein the extrusion cooked vegetable protein composition has a particle size distribution comprising (i) at least about 60% that pass through an about 4 mm mesh sieve and (ii) at most about 10% of the particles that pass through an about 0.8 mm mesh sieve
wherein, optionally, the extrusion cooked protein composition's particle size distribution further comprises from about 40% to about 60% of particles that rest on sieve having mesh size between about 2 mm
wherein, optionally, the legume protein is either a pea protein or a fava bean protein.

2. The extrusion cooked vegetable protein composition of claim 1 wherein
the legume protein is from a single legume type and is in an amount of from an amount from about 60 to about 69; and
wherein the extrusion cooked vegetable protein composition further comprises a carbohydrate in an amount from about 3% to about 9%.

3. The extrusion cooked vegetable protein composition of claim 1 wherein when soaked in ambient temperature deionized water for 10 minutes the extrusion cooked vegetable protein has:
a. a water holding capacity of from about 3.0 to about 4.5 g/g; and
b. a firmness or from about 3200 g and 5400 g.

4. The extrusion cooked vegetable protein composition of claim 1 further comprising a fiber in an amount from about 3% to about 9% or from about 5% to about 9%.

5. The extrusion cooked vegetable protein composition of claim 1 further having a bulk density of from about 100 to 260 g/L.

6. The composition of claim 1 being having unhydrated moisture content from about 5% to about 9%.

7. The extrusion cooked vegetable protein composition of claim 1 having a molecular weight distribution wherein at least 25% of the proteins in the composition have molecular weight of less than 10 kDa.

8. The extrusion cooked vegetable protein composition of claim 1 having a molecular weight distribution wherein less than 30% of the composition is aggregates having a molecular weight greater than about 250 kDa.

9. The extrusion cooked vegetable protein composition of claim 1 having an expansion index of from about 0.79 to about 2.77.

10. The extrusion cooked vegetable protein composition of claim 1 wherein the protein, carbohydrate and, optional fiber are from pea.

11. A food composition comprising the extrusion cooked vegetable protein composition and a second edible ingredient
wherein the second ingredient is an edible substrate, and wherein the extrusion cooked vegetable protein composition is a coating that coats the edible substrate
wherein the extrusion cooked vegetable protein composition has protein content greater than about 60%
wherein the extrusion cooked vegetable protein composition has a particle size distribution comprising (i) at least about 60% that pass through an about 4 mm mesh sieve and (ii) at most about 10% of the particles that pass through an about 0.8 mm mesh sieve.

12. (canceled)

13. The food composition of claim 11 wherein the coating further comprises a starch or flour.

14. The food composition of claim 11 wherein the coating further comprises a starch or flour selected from the group consisting of wheat flour, rice flour, waxy rice four, tapioca flour, waxy tapioca flour, tapioca starch, waxy tapioca starch, waxy rice starch, rice starch, corn starch, waxy corn starch, pea starch, potato starch, waxy potato starch, high amylose corn starch and mixtures thereof.

15. The food composition of claim 11 wherein the coating comprises the extrusion cooked vegetable protein composition in an amount greater than about 35% (wt. %) to about 100%.

16. (canceled)

17. A method of making an extrusion cooked vegetable protein composition comprising
a. obtaining a mixture of:
i. a first legume protein component in amount of from about 70% to about 90%; and
ii. a second legume protein component in an amount of from about 10% to about 30%;
b. feeding the mixture into an extruder;
c. extruding the mixture using the extruder to obtain an extrusion cooked vegetable protein composition; and
d. wherein the extrusion cooked vegetable protein composition has a particle size distribution comprising (i) at least about 60% to about 90% of particles of particles that pass through an about 4 mm mesh sieve and (ii) at most about 10% the particles that pass through an about 0.8 mm mesh sieve
wherein, optionally, the extrusion cooked protein composition's particle size distribution further comprises from about 40% to about 60% or to about 50% of particles that rest on sieve having mesh size between about 2 mm;
wherein optionally, the legume protein is a pea protein or a fava bean protein; and
wherein the first and second legume protein components are the same legume type.

18. The method of claim 17 wherein the second legume protein component is a native legume protein component, and has a denaturation enthalpy greater than 9 J/g.

19. The method of claim 17 the first legume protein component has a denaturation enthalpy of less than about 4 J/g.

20. The method of claim 17 wherein the extruding step comprises extruding the mixture using a specific mechanical energy of from about 250 to about 270 W*hr/kg.
